(19) United States
(12) Patent Application Publication
(10) Pub. No.: US 2025/0282338 A1
(43) Pub. Date: Sep. 11, 2025

(54) METHOD FOR DETERMINING THE MOTOR CONSTANTS OF AN ELECTRIC MOTOR OF AN ELECTROMECHANICAL PARKING BRAKE, CONTROL METHOD FOR OPERATING A DRIVE OF AN ELECTROMECHANICAL PARKING BRAKE, AND ELECTROMECHANICAL PARKING BRAKE

(71) Applicant: ZF Active Safety GmbH, Koblenz (DE)

(72) Inventors: Benedikt Ohlig, Vallendar (DE); Erwin Josef Michels, Kail (DE)

(73) Assignee: ZF Active Safety GmbH, Koblenz (DE)

(21) Appl. No.: 19/071,025

(22) Filed: Mar. 5, 2025

(30) Foreign Application Priority Data
Mar. 6, 2024 (DE) 102024106476.5

(51) Int. Cl. B60T 17/22; B60T 7/12; B60T 13/74

(52) U.S. Cl. CPC B60T 17/22; B60T 7/12; B60T 13/745

(57) ABSTRACT

A method for determining the motor speed constant of an electric motor of an electromechanical parking brake, a control method for operating a drive of an electromechanical parking brake and an electromechanical parking brake with an electronic controller and a drive are presented. A spindle nut of the electromechanical parking brake is arranged at least partially within a hydraulically actuable actuating piston of a braking device to be displaceable such that the spindle nut is moveable against the actuating piston. Before determining the motor speed constant, if a required idle distance between the spindle nut and the actuating piston is not present, the hydraulically actuable actuating piston is supplied with a hydraulic fluid in accordance with an idle distance pressure and at least the idle distance is set. The electric motor is then energized and a measurement run is carried out within the idle distance.

### CROSS-REFERENCE TO RELATED APPLICATIONS

This application claims priority to German Patent Application No. 102024131991.7, filed Nov. 4, 2024, the disclosure of which is incorporated herein by reference in its entirety.

### TECHNICAL FIELD

The present disclosure relates to a method for determining motor constants of an electric motor of an electromechanical parking brake, a control method for operating a drive of an electromechanical parking brake and an electromechanical parking brake with a controller and a drive.

### BACKGROUND

Electromechanical parking brakes are used in many instances nowadays, e.g. as a component of a braking device (vehicle brake) that is complementary to a hydraulic service brake. In this case, the electromechanical parking brakes serve as braking devices which can continuously ensure frictional engagement of brake pads with a brake disc, even if, for example, the pressure of a hydraulic circuit is not present, e.g. when the vehicle is switched off and parked.

In some arrangements, the electromechanical parking brake can have a spindle assembly with a nut/spindle combination. The electromechanical parking brake can then be integrated into a hydraulic service brake. A spindle nut of the electromechanical parking brake can then be arranged at least partially within a hydraulically actuable brake piston (hollow piston) of the service brake of the braking device (vehicle brake) so as to be displaceable in such a way that the spindle nut can be moved against the brake piston. For example, a rotation of the spindle can result in a translation of the spindle nut along a displacement axis, thus effectively ensuring a travel for the spindle nut of the parking brake. In this case, the rotation of the spindle can be brought about by an electric motor. Consequently, after reaching a contact point, the spindle nut can act on a brake piston of the braking device (enter into engagement with the brake piston) which includes the electromechanical parking brake and the hydraulic service brake. The brake piston can thereby be moved in the direction of the brake disc of the braking device, thereby enabling a brake pad coupled to the brake piston to be brought into frictional engagement with the brake disc at the point of support.

In some arrangements, the spindle nut can be positioned close to the piston top of the brake piston, e.g. when a small release clearance (small gaps/gap sizes) is required. If it is not aligned in an optimum manner for example, the spindle nut may then be continuously in contact with the brake piston, thereby giving rise to residual rubbing torques. For example, the brake pads in some arrangements may also be pressed continuously against the spindle nut on account of strong spring elements.

In these configurations, it may happen that a minimum travel distance for the execution of a reference movement by means of the electric motor in the idling mode in order to adjust the parking brake on the basis of a control method or in order to ascertain control parameters of the drive forming the basis of the parking brake cannot be ensured. In other words, the gap size between the spindle nut and the brake piston may be so small that it is not possible to ensure an adequate travel for the electric motor or the spindle nut in the idling mode, along which only negligible friction torques occur. On the contrary, residual rubbing torques may lead to the impermissibility of assuming torque-free idling of the electric motor. The execution of a control method would then lead to incorrect determination of the motor speed constant k_{E} and, as a consequence, to incorrect determination of other drive parameters, such as the total resistance R_{ges} of the drive.

For this reason, what is needed is to eliminate or at least reduce the disadvantages of the prior art in this regard. For example, there is a need to be able to provide an electromechanical parking brake in such a way that the permissible prerequisites for carrying out a control method in the form of a (substantially) frictionless minimum travel can be ensured.

### SUMMARY

A control method is disclosed herein that is set forth in the subject matter of the independent patent claim. Advantageous exemplary arrangements are specified in the dependent patent claims and the following description, each of which can represent aspects of the disclosure individually or in (sub)combination. Some aspects are explained with reference to devices, while others are explained with reference to methods. However, the features and advantages can each be interchanged in an appropriately corresponding manner.

According to one aspect, a method for determining the motor constants of an electric motor of an electromechanical parking brake is provided. The electromechanical parking brake is integrated into a hydraulic service brake (also referred to as a vehicle brake). A spindle nut of the electromechanical parking brake is arranged at least partially within a hydraulically actuable brake piston (also referred to as an actuating piston) of the braking device so as to be displaceable in such a way that the spindle nut can be moved against the brake piston (actuating piston). Before the determination of the motor speed constant k_{E}, if a required idle distance between the spindle nut and the actuating piston is not present, the hydraulically actuable brake piston of the braking device is supplied with a hydraulic fluid in accordance with an idle distance pressure and at least the idle distance is set. The electric motor is then energized and a measurement run is carried out within the idle distance.

That means that the hydraulic service brake of the braking device can be used to ensure the prerequisites to enable the previously outlined control method to be carried out on the basis of an idle distance ensured by a hydraulic pressure for the spindle nut. Thus, it is possible to produce a sufficient gap size between the hydraulically actuable brake piston (also referred to as an actuating piston) and the spindle nut to make it possible to ensure the minimum travel required to evaluate the electric motor in the idling mode in respect of its speed and the induced back EMF. During idling, the spindle nut moves in accordance with the measurement run brought about by the electric motor, which is in idling mode. Thus, even in the case of brake pistons subject to correspondingly strong springs, it is possible to ensure sufficient idle distances for the spindle nut to enable a control method for determining the parameters of the drive of the parking brake to be carried out. Consequently, the precision of control of the electromechanical parking brake is thereby increased.

In the present case, the idle distance can be interpreted as the minimum distance (minimum gap size) between the spindle nut and the brake piston that is required to enable the electric motor to be moved in an idling mode over a sufficient distance, for example, to enable the induced back EMF and the speed of the electric motor in the idling mode to be determined. While idling, during the execution of the control method, the electric motor is moved in the direction of the application state.

Here, the idle distance pressure should be interpreted to mean the pressure that is sufficient to ensure the idle distance between the spindle nut and the hydraulically actuable brake piston.

As a exemplary option, the idle distance pressure can be set during operation. It is thereby possible to ensure that a sufficient idle distance can be ensured even in the case of changing operating parameters of the braking device and, for example, of the electromechanical parking brake. The variability of the braking device is thereby increased, and therefore the method and also the outlined control method are more robust relative to influences on the braking device, e.g. ageing effects or brake pad wear.

As an option, the idle distance is greater than a threshold value that is specified or that can be set during operation. The variability of the method is thereby further increased since the idle distance can be varied in accordance with the desired characteristics. For certain operating scenarios of the braking device, for example, there may be a desire for the idle distance to be greater than it is for other operating scenarios.

In some exemplary arrangements, the idle distance pressure is set on the basis of the threshold value. Since the idle distance pressure has an effect on the idle distance brought about as a result of exerting the idle distance pressure, the idle distance pressure can be selected in a manner appropriate to requirements by variation of the threshold value provided for the idle distance. In this way, it is possible to ensure that an idle distance which is greater than the specified threshold value is always brought about.

As a option, an operating pressure that has already been exerted on the brake piston by the hydraulic fluid before the execution of the method is maintained during the method, taking into account the idle distance pressure. Since the braking device has both the hydraulic service brake and the electromechanical parking brake, it is of course possible that the hydraulic service brake will already have been actuated before the idle distance for executing the outlined control method is to be ensured. The actuation of the hydraulic service brake is associated with a service pressure acting on the brake piston and exerted by the hydraulic fluid. In this case, the already exerted operating pressure serves as a basic value, which is additionally increased by the idle distance pressure to enable the idle distance for the spindle nut relative to the brake piston to be ensured. Thus, the method under consideration makes it possible to maintain the desired manner of functioning of the hydraulic service brake even though the idle distance is ensured in order to enable the outlined control method to be carried out. The functionality of the method and of the outlined control method is thereby increased.

As an option, after the threshold value is reached, the electric motor is accelerated to a minimum idling speed and a back EMF induced by an idling motion of the electric motor is measured. In addition, the speed of the idling electric motor can be ascertained, e.g. by an asynchronous counter. This makes it possible to determine the motor speed constant k_{E}. On the basis of the motor speed constant k_{E}, it is then possible, as explained below, to determine the total resistance R_{ges} of the drive which has the electric motor. It is advantageously possible to ascertain the total resistance of the electric motor of the electromechanical parking brake without the need for a speed sensor for this purpose.

In some exemplary arrangements, after acceleration of the electric motor to the minimum idling speed and measurement of the induced back EMF, the electric motor is de-energized (no longer energized). After this, the electric motor continues to rotate owing to its inertia. It is thereby possible to extend the measurement interval for the idling of the electric motor. In this way, the motor speed constant k_{E} and thus also the total resistance R_{ges} can be determined with higher precision.

The electric motor can be, for example, a permanently excited DC motor.

According to another exemplary aspect, a braking device for a vehicle is provided, which has a hydraulically actuable service brake, an electromechanical parking brake and an electronic controller, and in which the electronic controller is configured to carry out the method as explained above.

In the control of electromechanical parking brakes, manufacturing tolerances or even wear on the brake pads lead to possible changes in the release clearance, that is to say the total of all air gaps (in general: gap sizes) between various components of the hydraulic service brake during the operation of the vehicle brake. For example, the gap between the friction side of the brake pad and the brake disc may increase in the course of time on account of wearing of a brake pad. This has the effect that the frictional engagement in the case when the parking brake is used is ensured only after a larger actuating travel of the electromechanical parking brake. This reduces comfort for the user since the larger gap leads both to an increase in the response time of the parking brake and to possible variation in the friction torques that occur.

To compensate for such effects, methods for operating the drive that has the parking brake are contemplated in which such effects can be compensated for as far as possible. For example, it is known to determine a combined signal from a current signal and a voltage signal of the electric motor on which the parking brake is based, the signal oscillations of said signals being assessed in order to obtain a rotation angle signal of the electric motor therefrom. In this way, it is possible to determine the speed of the electric motor, thereby enabling the drive of the parking brake to be controlled.

In these approaches, however, the starting point is formed by predetermined total resistances of the respective drive which has the electric motor of the electromechanical parking brake. Since the total resistance likewise has an effect on the actual motor speed of the electric motor, production tolerances or even ageing processes may lead to the assumed total resistance of the respective drive no longer corresponding to the actual total resistance of the drive. As a result, the precision of control of the drive which comprises the electromechanical parking brake is limited. This has the effect that the electromechanical parking brake does not have constant desired braking parameters, such as actuating travel or response time.

The disclosure is therefore directed to eliminating or at least reducing the disadvantages of the prior art. For example, the intention is to provide a possibility of enabling an electromechanical parking brake to be controlled more precisely than hitherto, thus increasing user comfort.

Exemplary arrangements are specified in the dependent patent claims and the following description, each of which can represent aspects of the disclosure individually or in (sub)combination. Some aspects are explained with reference to devices, while others are explained with reference to methods. However, the features and advantages can each be interchanged in an appropriately corresponding manner.

According to one aspect, a control method for the operation of a drive of an electromechanical parking brake is provided. The drive has an electric motor and is coupled to a voltage source. The control method comprises at least the following steps:

A motor speed and a first voltage value of an induced back EMF are acquired while the electric motor is idling (generator mode of the electric motor).

A motor speed constant in the idling condition is ascertained by an electronic controller on the basis of the motor speed and the first voltage value of the induced back EMF.

A total resistance of the drive is determined by the electronic controller on the basis of a second voltage value of a supply voltage provided by the voltage source and of a current value of the phase current which is established in the drive during idling.

This opens up the possibility of determining the total resistance of the drive without having to assume that it is fixed. Advantageously, only a few detected parameters of the drive are required. The total resistance determined in this way then makes it possible to increase precision in the control of the drive relative to previous approaches since the total resistance can be assumed to be constant over relatively long periods of time. For example, the control method under consideration does not require any assumption of the value of the total resistance of the drive but ensures that the total resistance can be determined from the intrinsic parameters of the drive during operation of the electric motor of the drive during idling. In this way, it is possible, for example, to compensate for deviations that are due, for example, to production tolerances. In addition, the contact force of the electromechanical parking brake can be set more precisely than hitherto. It is also possible to avoid residual rubbing torques. In addition, control of the drive of the electromechanical parking brake then also does not require the repeated evaluation of the signal oscillations of combined current and voltage signals. As a result, the effort involved in operating the drive as compared with previous approaches is reduced since the control method under consideration manages with a reduced computing power and a lower memory capacity requirement than known approaches.

In the present case, idling of the electric motor can be interpreted as operation of the electric motor at an idling speed, at which, however, the electric motor does not exert any significant mechanical torque on any other component (generator mode of the electric motor). This means that the rotor of the electric motor is not in mechanical engagement with some other component in such a way that a mechanical torque that is no longer negligible would be caused thereby. In the generator mode, however, (negligible) friction torques may occur owing, for example, to the translation of a component, e.g. a spindle nut, coupled to the electric motor.

In one exemplary arrangement, at least one component coupled to the electric motor or one component of the electric motor itself can move in the direction of the application state of the electromechanical parking brake during idling. However, the movement of the corresponding component does not cause any significant mechanical torques apart from negligible friction torques (this does not refer to friction torque that occurs in the case of frictional engagement of the brake pad with a brake disc).

The application state of the electromechanical parking brake should be interpreted as engagement of at least one brake pad with a brake disc. However, this frictional engagement (and thus the application state) does not occur during the execution of the idling mode. Overall, therefore, the electromechanical parking brake is thereby moved in the direction of the application state during the idling mode mentioned here.

As soon as the electric motor moves, a back EMF is induced in the electric motor as a function of the speed of the electric motor. This generally has the effect that the voltage that actually acts in the electric motor does not coincide with the electric voltage consumed by the electric motor. On the contrary, the electric voltage consumed is effectively reduced by the induced back EMF. In this case, the electric voltage consumed is ensured by a supply circuit of the drive which the electric motor has. For example, the supply circuit can have the voltage source and can be coupled to the electric motor.

In the present case, the electronic controller can be interpreted as a control device which has at least one data processing device. The electronic controller can have sensors or can at least be coupled thereto in order to be able to detect parameters during the control of the electric motor, e.g. voltage values or phase current values.

In the present case, the total resistance of the drive can be, for example, a sum of a series resistance and an effective electric armature resistance of the supply circuit in respect of the electric motor itself. In this context, the series resistance comprises, for example, resistances of lines, filter devices and components of the supply circuit of the drive that is required to supply the electric motor with corresponding voltages, thus ensuring that effective phase currents are established in the electric motor.

In some exemplary arrangements, it is assumed in determining the total resistance that the motor speed constant k_{E} of the electric motor in the generator mode of the electromechanical parking brake and the motor torque constant k_{M} (in the motor mode of the electric motor) coincide, i.e.: k_{E}=k_{M}. Determination of the total resistance of the drive is thereby advantageously simplified.

The motor speed ω_{RC} in the idling mode may be detected by an asynchronous counter (also referred to as a ripple counter) during a measurement interval. Thus, during the measurement interval, the characteristic of the induced back EMF U_{ind} is determined for a period of time. The detected signal characteristic of the induced back EMF U_{ind} is then evaluated by the electronic controller in respect of the local maxima or minima, which are determined by the positions of the rotor poles relative to the stator poles (e.g. overlap versus no overlap). With a knowledge of the duration of the measurement interval, it is thus possible to ascertain the motor speed ω_{RC} without the need for a speed sensor for this purpose. As a result, the construction of the drive is advantageously very compact and less complex. Since no mechanical torque (or only a negligible torque) is exerted by the electric motor during idling, the motor speed constant k_{E} can then advantageously be determined in a very efficient way as:

$${k}_{E} = \frac{{U}_{ind}}{{ω}_{RC}} .$$

In some exemplary arrangements, the asynchronous counter can be designed as part of the electronic controller. In general, the asynchronous counter can also be separate from the electronic controller and can transmit the corresponding count values to the electronic controller.

Assuming that the motor speed constant k_{E} (in the generator mode of the electric motor) coincides with the motor torque constant k_{M} (in the motor mode of the electric motor), the total resistance R_{ges} of the drive can then be determined, taking into account the voltage value of the voltage source U_{ECU}:

$${R}_{ges} = {R}_{V} + {R}_{A} = \frac{{U}_{ECU} - {U}_{ind}}{{I}_{A}} .$$

Here, R_{V} denotes a series resistance, which is due to the electronic supply circuit for controlling the electric motor. In contrast, R_{A} denotes the intrinsic armature resistance of the supply circuit in respect of the electric motor, which may be due, for example, to line resistances of the windings of the electric motor. In the present case, it is assumed that the phase current I_{A} established in the electric motor is constant with respect to time

$$( \frac{{di}_{A} ( t )}{dt} = 0 ) ,$$

this being due to the fact that the electric motor is idling and does not cause any mechanical torque that has to be taken into account. In this context, i_{A} denotes the time-variable magnitude of the phase current established in the electric motor.

As an option, the measurement interval is between 50 ms and 30 s, preferably between 100 ms and 25 s, as a further preference between 200 ms and 20 s. This shows that only a very short measurement interval is required to enable the control method under consideration to be used. For example, a stoppage of the vehicle can be used to provide the measurement interval for the control method and to allow the corresponding determination of the motor speed and of the induced back EMF.

In one exemplary arrangement, at least the determined total resistance R_{ges} of the drive and the ascertained motor speed constant k_{E} in the application state of the electric motor are used in the electronic controller to ascertain the motor speed ω of the electric motor in the application state. As a good approximation, it is possible to posit that the total resistance of the drive is constant with respect to time for the speed determination in the application state of the electromechanical parking brake (at least beyond certain periods of time). For example, it is possible to posit that the total resistance of the drive during the implementation of the application state of the electromechanical parking brake from the idling state is constant. This assumption is based on the fact that the temperature of the motor and of the supply circuit of the electric motor changes only to a negligible extent during the implementation of the application state and during the measurement interval for the determination of the motor speed in the idling mode. In addition, it is posited that the motor speed constant k_{E} in the generator mode of the electric motor and the motor torque constant k_{M} in the motor mode coincide. As a consequence, the speed of the electric motor can also be efficiently and precisely determined without a speed sensor. A compact and precise control method for controlling the electric motor is thereby made possible.

As an option, at least the second voltage value of the supply voltage U_{ECU} provided by the voltage source and the current value of the phase current i_{A} that is established in the drive in the application state of the electric motor are additionally used in ascertaining the motor speed w of the electric motor in the application state. This means that at most only a few parameters, which can be detected easily and precisely, have to be detected for speed determination. The speed of the electric motor can then be efficiently determined by way of:

$$ω = \frac{{U}_{ECU} - {i}_{A} \cdot {R}_{ges}}{{k}_{M}} .$$

In this way, the motor speed of the electric motor of the electromechanical parking brake can also be determined very efficiently for the application state of the electromechanical parking brake. This is made possible even though the phase current i_{A} established in the electric motor and, of course, the supply voltage U_{ECU} provided are variable with respect to time. To detect these variables, the electronic controller has corresponding sensors or is coupled therewith. In this way, a robust but compact control method for the drive of the electromechanical parking brake is ensured. The computing power for carrying out the control method is advantageously reduced in comparison with known approaches. In addition, it is not necessary for an asynchronous counter to be used continuously in order to evaluate signals.

By virtue of the possibility of ascertaining the speed of the electric motor, it is thereby also possible to ascertain the position of the rotor relative to the stator since the rotation angle of the rotor relative to the stator is determined by the motor speed on the basis of a reference position. In this way, the precision of control of the electric motor is improved in comparison with known approaches.

In some exemplary arrangements, a motor torque M of the electric motor is also determined by the electronic controller at least on the basis of the ascertained motor torque constant k_{M}:

$$M = {k}_{M} . \sqrt{\frac{P}{{R}_{ges}}}$$

Here, P denotes the electric power of the electric motor, which can be ascertained from the detected parameters, e.g. by the phase current i_{A} established in the electric motor, the supply voltage U_{ECU} provided and the back EMF U_{ind} induced as a function of the speed w. In the application state, the motor torque produced by the electric motor is equivalent to the application force F_{Zuspann} exerted, by which the friction pads are pressed onto the brake disc. As a result, control of the parking brake can be carried out even more precisely.

On the basis of the determination of the motor torque M, it is also possible to determine the point of support (also referred to as “touch disc” point or “setpoint”), that is to say the point along the travel of the electromechanical parking brake at which at least indirect engagement between at least one component of the parking brake, e.g. a spindle nut, and the brake disc occurs and a no longer negligible friction torque is produced. In other words, all the gap sizes within the braking device are reduced to zero at the point of support. The release clearance of the braking device is then bridged. Any further movement of the parking brake, starting from the point of support, accordingly leads to a brake pad being pressed against the brake disc and thus to the changing or production of a braking force. Here, the spindle nut typically acts on a brake piston which is coupled to a brake pad and which enters into engagement with the brake disc at the point of support. Determination of the point of support is made possible by the fact that the characteristic of the variation in the phase current established in the electric motor due to the engagement with the brake disc changes significantly with the production of no longer negligible friction torques. This means that the phase current has different gradients on both sides of the point of support, depending on the travel. This likewise causes a significant change in the motor torque M of the electric motor as soon as the point of support is reached. By virtue of the knowledge of the position of the point of support along the travel of the electromechanical parking brake, for example, of a spindle nut thereof, control of the electromechanical parking brake can be performed more precisely than hitherto. It is then possible to ensure, for example, that a release clearance of the braking device does not exceed a predetermined threshold value. In one exemplary arrangement, it is possible to select and ensure desired gap sizes between the spindle nut of the electromechanical parking brake and the top of the brake piston of a hydraulic service brake as part of the control process. In this way, it is possible to exert influence over the response time and the actuating travel of the electromechanical parking brake.

In addition, the control under consideration also makes it possible to determine the maximum current of the phase current i_{A,Max} of the drive and/or the maximum motor torque M_{Max}. In this case, it is possible to take account of the fact that the maximum phase current i_{A,Max} established in the electric motor can be determined with a knowledge of the total resistance R_{ges} of the drive, which is assumed to be constant, as a function of the supply voltage U_{ECU} provided. This need then only be allowed for with the above formula in order to determine the maximum motor torque M_{Max}, from which it is also possible to derive the maximum achievable application force F_{Zuspann,Max}. As a consequence, control of the electromechanical parking brake can be performed even more precisely than hitherto.

As an option, the control method can be carried out repeatedly in order to determine at least updated values of the total resistance R_{ges} of the drive. For example, ageing processes can lead to a change in the total resistance R_{ges} of the drive. By carrying out the outlined control method repeatedly, updated values of the total resistance R_{ges} can be determined, thus enabling the control method for operating the electromechanical parking brake to be carried out again, at least for a certain period of time, in the manner outlined here, in particular in a compact, precise and efficient way.

According to a further aspect, an electromechanical parking brake with an electronic controller and a drive is also provided. The drive has an electric motor. The drive can be coupled to a voltage source that provides a supply voltage. The electronic controller is configured to carry out the control method as explained above.

The advantages that are obtained by the control method explained above are also achieved by the parking brake described here.

The electronic controller comprises at least one data processing device.

According to an additional aspect, a vehicle having an electromechanical parking brake explained above or a braking device as described above is also provided. A vehicle can be interpreted to mean a land vehicle, namely inter alia an all-terrain or road vehicle, such as a passenger car, a bus, a heavy goods vehicle or some other utility vehicle. Vehicles can be manned or unmanned. Vehicles can be driven at least in part electrically.

### BRIEF DESCRIPTION OF THE DRAWINGS

The disclosure and further advantageous exemplary arrangements and developments thereof are described and explained in greater detail below with reference to the example illustrated in the drawing. The features that can be found in the description and the drawing can, according to the disclosure, be used individually or together in any desired combination. In the drawings:

FIG. 1 shows a schematic illustration of a braking device for a vehicle comprising an electromechanical parking brake according to one exemplary arrangement of the disclosure,

FIG. 2 shows a schematic illustration of an equivalent circuit diagram of the drive of the electromechanical parking brake according to one exemplary arrangement of the disclosure,

FIG. 3 shows a schematic illustration of a control method for operating a drive of an electromechanical parking brake according to one exemplary arrangement of the disclosure, and

FIG. 4 shows a schematic illustration of a method for determining the motor speed constant of an electric motor of an electromechanical parking brake according to one exemplary arrangement of the disclosure.

### DETAILED DESCRIPTION

All of the features disclosed below with respect to the exemplary arrangements and/or the accompanying figures can be combined, alone or in any subcombination, with features of the aspects of the present disclosure, including features of preferred arrangements, provided that the resulting combination of features is worthwhile for a person skilled in the art.

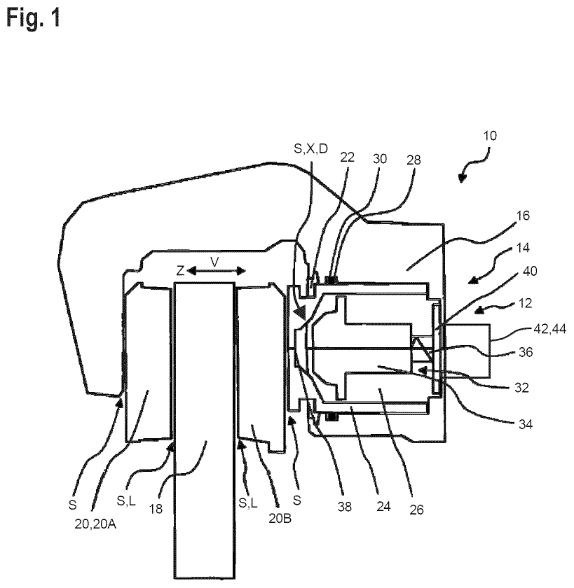

FIG. 1 shows a schematic illustration of a braking device 10 for a vehicle (also referred to as a vehicle brake) comprising an electromechanical parking brake 12 according to one exemplary arrangement of the disclosure.

Mechanically, the braking device 10 is designed as a widely known floating calliper brake, wherein only selected components of the braking device 10 are illustrated. In addition to the electromechanical parking brake 12, the braking device also comprises a hydraulically actuable service brake 14, which at least partially surrounds the electromechanical parking brake 12, as will be explained in greater detail below.

The braking device 10 has a brake housing 16 in the form of a known brake calliper and a brake disc 18 coupled to a vehicle wheel (not illustrated) for conjoint rotation therewith. Situated opposite one another on each side of the brake disc 18 are brake pads 20, 20A, 20B (also known as friction pads), which can be brought into contact with the brake disc 18 to obtain a braking force. For this purpose, a service brake 14 of the braking device 10 comprises a displaceable actuating piston 24 (also referred to as a brake piston), which is accommodated in a hole 22 in the brake piston 16. This piston is designed as a hollow piston and has a hydraulic chamber 26 in its interior. By introducing and discharging hydraulic fluid into and out of the hydraulic chamber 26, a hydraulic pressure in the hydraulic chamber 26 can be varied, and the actuating piston 24 can be moved along a displacement axis V in a generally known manner. Here, a movement to the left in FIG. 1 along the displacement axis V corresponds to a movement in an application direction Z of the braking device 10. Overall, the brake pads 20 can thus be brought into contact with the brake disc 18 to obtain a braking force and, when the hydraulic pressure is reduced, can be released from the said disc, in order to ensure the functioning of the service brake 14.

To obtain the desired return movement of the actuating piston 24 into its initial position after the reduction of the hydraulic pressure, the braking device 10 furthermore comprises a schematically indicated seal 28. This is accommodated in a groove 30 starting from the hole 22 and rests against an outer wall of the actuating piston 24. In a generally known manner, the seal 28 provides what is known as a “rollback” function, which has the effect of helping to push the actuating piston 24 back into its initial position when the hydraulic pressure is reduced.

The electromechanical parking brake 12 is likewise accommodated within the hydraulic chamber 26 and can furthermore likewise move along the displacement axis V. Mechanically, the parking brake 12 is again designed according to known solutions and comprises an actuator unit 32, which is designed as a nut/spindle assembly. To be more precise, the actuator unit 32 comprises a spindle nut 34, which can be moved in translation along the displacement axis V by rotation of a spindle 36. In this case, the spindle nut 34 can also be brought into contact with a piston top 38, which is designed as an internal end wall region of the actuating piston 24, the said end wall region lying opposite the spindle nut 34 and delimiting the hydraulic chamber 26.

The actuator unit 32 is furthermore connected via a coupling region 40 to the brake housing 16, wherein a schematically illustrated electric-motor drive 42 is flanged from the outside to the brake housing 16 in the coupling region 40. The drive 42 comprises at least one electric motor 44. Due to the electric motor 44, the drive 42 drives the spindle 36 in rotation in order to ensure the desired displacement movement of the spindle nut 34 along the axis V.

When the service brake 14 and the electromechanical parking brake 12 are not being actuated, there are gaps S between various components within the braking device, and these must be bridged in order to obtain a braking force. The gaps concerned are (from left to right): a gap S between the brake housing 16 and the left-hand brake pad 20A, a gap S between this left-hand brake pad 20A and the brake disc 18, a gap S between the right-hand brake pad 20B and the brake disc 18, and a gap S between the actuating piston 24 and the right-hand brake pad 20B. To produce braking forces, the electromechanical parking brake 12 must additionally overcome a gap S between the spindle nut 34 and the piston top 38 of the actuating piston 24.

The gaps S between the brake pads 20 and the brake disc 18 are generally referred to as a “release clearance” or “braking release clearance”, for which reason these gaps S are additionally provided with the reference sign L. The release clearance L should assume a predetermined minimum value in order to avoid residual rubbing torques in the sense of unwanted contact between the brake pads 20 and the brake disc 18 when the braking device 10 is unactuated.

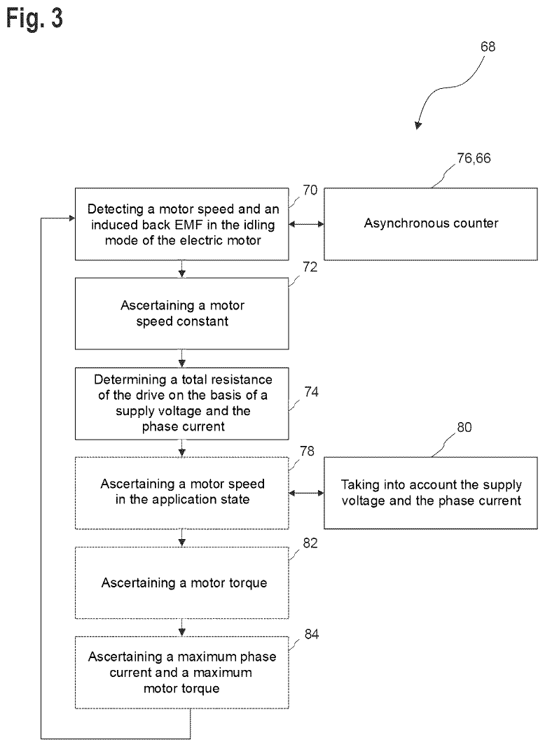

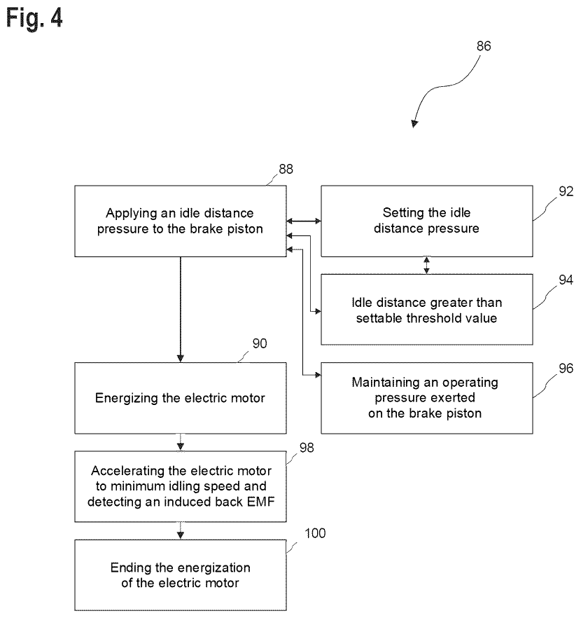

The gap S between the spindle nut 34 and the piston top 38 or the actuating piston 24 is a safety clearance, for which reason this gap S is additionally provided with the reference sign X. For reasons of system safety, the safety clearance X should in general assume a predetermined minimum value to enable correct functioning of the service brake 14 to be ensured when the electromechanical parking brake 12 is not being actuated. The gap size S between the spindle nut 34 and the piston top 38 of the actuating piston 24 is additionally also designated as idle distance D. Here, the idle distance D designates a travel of the spindle nut 34 along the displacement axis V in the direction of the application state required for the control method outlined in FIG. 3. As explained further below, it may happen that there is no idle distance D per se in certain operating situations of the braking device 10 or in certain configurations thereof. It is for this eventuality that the method from FIG. 4 is explained, by which the required idle distance D can be produced, thus making possible the control method from FIG. 3 as a result.

In the case of a conventional driver-controlled service brake operation, a hydraulic pressure is built up in the hydraulic chamber 26, and the actuating piston 24 is moved along the application direction Z into an actuating position in which braking force is produced. During this process, it comes into contact with the right-hand brake pad 20B, brings the latter into contact with the brake disc 18 and applies the braking device 10 in a known manner in accordance with the floating calliper-type construction. During this process, all the gap sizes S, including the release clearance L, are bridged, with the exception of the safety clearance X between the spindle nut 34 and the piston top 38 of the actuating piston 24. To reduce the braking force, the actuating piston 24 moves counter to the application direction Z as a consequence of a reduction in the hydraulic pressure and with “rollback” assistance by the seal 28, whereupon the previously bridged gap sizes S, L are re-established.

The electromechanical parking brake 12 can generally be activated in the presence or absence of a hydraulic pressure (that is to say independently of the service brake 14) in order to move the actuating piston 24 into the actuating position thereof and/or to fix it mechanically therein. For this purpose, the spindle nut 34 is moved along the axis V in the manner described above and, during this process, is supported on the piston top 38 (at least in the case of movement in the application direction Z).

For the control method according to the exemplary arrangement shown in FIG. 3, it is envisaged that activation of the parking brake 12 takes place without prior production of a hydraulic pressure, that is to say that the braking device 10 is generally kept free from a hydraulic pressure.

This is in contrast with the exemplary arrangement of an operating situation shown in FIG. 4, in which the idle distance D between the spindle nut 34 and the piston top 38 of the actuating piston 24 is not present but must first of all be brought about. This can occur, for example, when the brake pads 20 and, as a consequence, also the actuating piston 24 are pressed continuously against the spindle nut 34 owing to the use of strong restoring springs (spring elements) (e.g. in the case of “zero drag callipers”) or at least the gap size S between the spindle nut 34 and the piston top 38 is smaller than the idle distance D. In addition, this situation can also occur even if, on account of the restoring elements used, a hydraulic pressure produced by the service brake 14 is not sufficient to ensure the idle distance D. In this case, the method illustrated in FIG. 4 can be used to bring about the idle distance D.

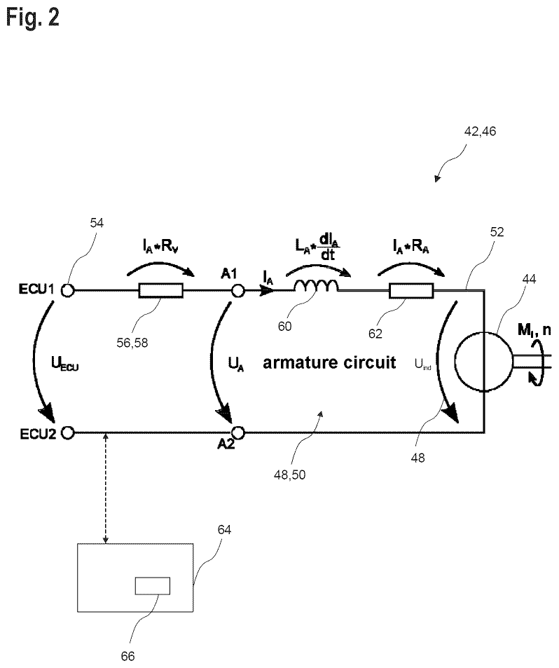

FIG. 2 shows a schematic illustration of an equivalent circuit diagram 46 of the drive 42 of the electromechanical parking brake 12 according to one exemplary arrangement of the disclosure.

Here, the actual supply circuit 48 of the drive 42 for supplying the electric motor 44 is illustrated in the form of an equivalent circuit diagram 46, which has an armature circuit 50. The electric motor 44 is supplied with electric signals, for example phase voltages, by corresponding supply lines 52 of the armature circuit 50. Owing to the relative positions of the magnet poles of the electric motor 44 as a function of the motor speed w, the phase currents i(t) within the electric motor vary with respect to time on the basis of the phase voltages.

In order to be able to provide the phase voltages, the supply circuit 48 has at least one voltage source 54 or is coupled thereto. In the present case, a supply voltage U_{ECU} is provided for the drive 42 across the connection terminals of the voltage source 54.

According to this exemplary arrangement, the supply circuit 48 furthermore has an input portion 56 with a series resistor 58 R_{V}, which can perform filter functions, for example, in order to suppress or at least attenuate signal disturbances. The exact design of the input portion 56 is of no further significance for the disclosure. In all cases, an (effective) series resistor 58 R_{V} of the supply circuit 48 of the drive 42 is formed by the input portion 56. By way of the series resistor 58, there is a drop in a corresponding current I_{A} and (via the terminals A1, A2) a corresponding voltage U_{A}.

The armature circuit 50 comprises further components, in this case, for example, in the form of an inductor 60 L_{A} and of an armature resistor 62 R_{A}. In this equivalent circuit diagram 46, the armature resistor (also referred to as a drive resistor) comprises the intrinsic line resistances of the electric motor 44. The precise configuration of the armature circuit 50 may deviate from the exemplary arrangement shown here but is not essential to the disclosure. Ultimately, time-variable phase voltages are provided via the supply lines 52 for the electric motor 44, by means of which time-variable phase currents i(t) are driven in the electric motor 44 and established in the electric motor 44. Owing to the phase currents i(t), the electric motor provides a motor torque M, by means of which a component, e.g. the spindle 36, coupled to the electric motor 44 of the drive 42 can be moved. Owing to the rotation of the spindle 36, the spindle nut 34 can be moved along the displacement axis V.

In the present case, the electric motor 44 is designed as a permanently excited DC motor. The operating characteristic of the electric motor 44 is determined by its total resistance R_{ges} and its operating constants, that is to say the speed constant k_{E} in the generator mode of the electric motor and the torque constant k_{M} in the motor mode. For the control method explained below, it is assumed that the total resistance R_{ges} is constant with respect to time and that the motor speed constant k_{E} in the generator mode of the electric motor and the motor torque constant k_{M} in the motor mode coincide with one another. The total resistance R_{ges} of the drive 42 is made up of the sum of the series resistance R_{V} 58 and of the armature resistance R_{A} 62 of the supply circuit 48: R_{ges}=R_{V}+R_{A}.

Owing to the rotation of the rotor of the electric motor 44, a back EMF U_{ind} is induced in the windings of the electric motor 44. This effectively reduces the voltage amplitude acting in the electric motor 44 on account of the phase voltages received.

The braking device 10 has at least one electronic controller 64, which is coupled to the supply circuit 48 of the drive 42 and is configured to control the operation of the electric motor 44, e.g. on the basis of the supply voltage U_{ECU} provided by the voltage source 54. For this purpose, the electronic controller can output corresponding pulse-width-modulated actuating signals, for example. In all cases, the electronic controller 64 is configured, by sensors, to detect the voltage values of the supply voltage U_{ECU}, of the induced back EMF U_{ind} (in the generator mode when there is no supply voltage U_{ECU}) and of the phase currents i(t) that are established in the electric motor 44. In this case, the sensors can be internal or external with respect to the electronic controller.

In addition, the electronic controller according to this exemplary arrangement also comprises an asynchronous counter 66, which is configured to detect local minima and/or maxima of signals, e.g. of the induced back EMF U_{ind}, e.g. while the electric motor 44 is idling, when the torque M brought about by the electric motor 44 is substantially zero.

FIG. 3 shows a schematic illustration of a control method 68 for operating a drive 42 with an electromechanical parking brake 12 according to one exemplary arrangement of the disclosure. Optional steps are illustrated in dashed lines.

The control method 68 first of all comprises a step 70, in which a motor speed w and a first voltage value of the back EMF U_{ind} induced by the motor rotation are detected while the electric motor 44 is idling. For this purpose, it is possible, for example, to use the electronic controller 64, which has corresponding sensors or is coupled therewith. While the electric motor 44 is idling, no torque or only a negligible torque M is output by the electric motor 44.

In order to detect the motor speed w, an asynchronous counter 66, for example, can be used by the electronic controller 64 according to the optional step 76 as a refinement of step 70. Due to the asynchronous counter 66, the local minima and/or maxima of the detected induced back EMF U_{ind} during a specified time period can be evaluated, thereby enabling the motor speed ω_{RC} to be determined.

As an option, step 70 can be designed such that the electromechanical parking brake 12 is moved in the direction of the application state by the electric motor 44 during the determination in accordance with step 70. This means that, for example, the spindle nut 34 can be moved along the displacement axis V in the direction of the brake disc 18 by the rotation of the spindle 36 without, however, the spindle nut 34 coming into contact with the piston top 38 of the actuating piston 24 (brake piston). Since the spindle nut 34 can be moved along the displacement axis V substantially without resistance, apart from negligible friction torques, only a negligible torque M is then expended by the electric motor 44.

From this, it is also clear that the spindle nut 34 travels an idle distance D along the displacement axis V during step 70 while the electric motor 44 is idling. The size of the idle distance D is based on a measurement interval as an optional refinement of step 70, for which the induced back EMF U_{ind} is evaluated. According to the exemplary arrangement under consideration, the measurement interval has a duration of between 200 ms and 20 s.

The control method 68 comprises the subsequent step 72, in which a motor speed constant k_{E} while the electric motor 44 is idling in the generator mode is ascertained by the electronic controller 64 on the basis of the motor speed ω_{RC} and the first voltage value of the induced back EMF U_{ind}. This can be performed by the formula already explained above:

$${k}_{E} = \frac{{U}_{ind}}{{ω}_{RC}} .$$

During the further progress of the control method 68, it is assumed that the motor speed constant k_{E} while the electric motor 44 is idling coincides with the motor torque constant k_{M} of the electric motor 44 in the motor mode.

In the following step 74, the total resistance R_{ges} of the drive 42 is then determined by the electronic controller 64 on the basis of a second voltage value of a supply voltage U_{ECU} provided by the voltage source 54 and of a current value of the phase current I_{A} which is established in the drive 42 during idling:

$${R}_{ges} = {R}_{V} + {R}_{A} = \frac{{U}_{ECU} - {U}_{ind}}{{I}_{A}} .$$

Here, use is made of the fact that, while the electric motor 44 is idling, it can be assumed that the phase current I_{A} established is constant with respect to time. As a result, the operating parameters of the electric motor 44 are known in general, and therefore precise control of the electric motor 44 is made possible, even in the motor mode.

Accordingly, the control method 68 can be further developed by the optional step 78, in which at least the determined total resistance R_{ges} of the drive 42 and the ascertained motor speed constant k_{E} in the application state of the electric motor 44 are used in the electronic controller 64 in order to ascertain the motor speed w of the electric motor 44 in the application state:

$$ω = \frac{{U}_{ECU} - {i}_{A} \cdot {R}_{ges}}{{k}_{M}} .$$

For example, use is made here of the fact that the ascertained motor speed constant k_{E} in the generator mode of the electric motor 44 coincides with the motor torque constant k_{M} in the motor mode of the electric motor 44.

Step 78 can be developed further by the optional step 80, in which, during the determination of the motor speed w in the motor mode of the electric motor 44, at least the second voltage value of the supply voltage U_{ECU} provided by the voltage source 54 and the current value of the phase current i_{A}(t) that is established in the drive 42 in the application state of the electric motor 44 are additionally taken into account. In this way, the motor speed w for all operating states of the electric motor 44 and hence of the spindle nut 34 along the displacement axis V can be determined. For example, it is also possible to infer from the motor speed w the angular position of the electric motor 44 and thus the position of the spindle nut 34 along the displacement axis V.

The control method 68 can also be further developed by the optional step 82, in which a motor torque M of the electric motor 44 is determined by the electronic controller 64 at least on the basis of the ascertained motor torque constant k_{M}:

$$M = {k}_{M} . \sqrt{\frac{P}{{R}_{ges}}}$$

This makes it possible to ascertain the point of support of the braking device 10 along the displacement axis V. That is to say, it is possible to determine the point along the displacement axis V at which the displacement of the spindle nut 34 leads to the brake pads 20 entering into engagement with the brake disc 18. In general, the position of the point of support along the displacement axis V may vary with time, e.g. because the brake pads 20 wear. On the basis of the determination of the point of support, it is possible to set desired actuating travels and response times of the electromechanical parking brake 12, e.g. by the electronic controller 64.

The control method 68 can also be further developed by the optional step 84, in which the determined total resistance R_{ges} of the drive 42 and the second voltage value of the supply voltage U_{ECU} provided by the voltage source 54 are used in the electronic controller 64 to determine a maximum current i_{A,Max}(t) of the phase current of the drive 42 and/or a maximum motor torque M_{Max} of the electric motor 44. Here, the maximum motor torque M_{Max} of the electric motor 44 corresponds to a maximum application force F_{Zuspann,Max} to be provided, with which the brake pads 20 can be pressed against the brake disc 18. With a knowledge of the maximum current i_{A,Max}(t) of the phase current and/or of the maximum motor torque M_{Max} of the electric motor 44, the precision of control of the electromechanical parking brake 12 can be increased even further. In this way, comfort for the user can be increased.

In principle, the control method 68 does not depend on being carried out repeatedly since the total resistance R_{ges} of the drive 42 can be assumed to be constant over relatively long periods of time. However, in order, for example, to counteract ageing effects such as variations in temperature dependence, the control method 68 can also be carried out repeatedly, in which case only updated values of the motor speed constant k_{E} in the generator mode of the electric motor 44 and of the total resistance R_{ges} of the drive 42 have to be determined, whereby the other variables are obtained in a corresponding manner.

FIG. 4 shows a schematic illustration of a method 86 for determining the motor speed constant k_{E} of an electric motor 44 in the generator mode of an electromechanical parking brake 12 according to one exemplary arrangement of the disclosure. The method 86 can optionally be developed further with one or more steps or with the entire control method 68 from FIG. 3, which is/are then linked to the method 86.

As already explained, it may happen in certain operating situations of the electromechanical parking brake 12 that the idle distance D between the spindle nut 34 and the piston top 38 of the actuating piston 24 is not present from the outset for the control method 68. In this case, the spindle nut 34 of the electromagnetic parking brake 12 cannot be moved along the displacement axis V to a sufficient extent, in accordance with idle operation of the electric motor 44, to enable reliable determination of the motor speed constant k_{E} of an electric motor 44 in the generator mode. The method 86 illustrated here provides a remedy for this case.

In step 88 of the method 86, the hydraulic service brake 14 of the braking device 10 is used in that, before the determination of the motor speed constant k_{E} in accordance with the control method 68, if a required idle distance D between the spindle nut 34 and the actuating piston 24 is not present, the hydraulically actuable actuating piston 24 of the braking device 10 is supplied with a hydraulic fluid in accordance with an idle distance pressure P_{D} and at least the idle distance D between the spindle nut 34 and the piston top 38 of the actuating piston 24 is set. This means that the spindle nut 34 is effectively moved away from the piston top 38 of the actuating piston 24 by increasing the pressure in the hydraulic chamber 26. For example, the actuating piston 24 can be moved further along the displacement axis V in the direction of the brake disc 18, thereby increasing the gap between the spindle nut 34 and the piston top 38.

As an option, step 88 can be further developed in various ways. For example, the idle distance pressure P_{D} can be set in operation in accordance with the optional step 92. This increases the variability of the method 86, e.g. if adaptation of the idle distance pressure P_{D} is necessary on account of changed operating parameters of the braking device 10.

As an option, step 88 can also be developed further by step 94, in which the idle distance D is greater than a threshold value S1 that is specified or that can be set during operation. For example, the threshold value S1 can be determined by the fact that the motor speed ω_{RC} is determined for a certain time period in the generator mode of the electric motor 44, this corresponding to a corresponding idle distance D. If the time period is varied, this can also make it necessary to adapt the idle distance D.

Furthermore, step 88 can also be developed further in accordance with a combination of steps 92 and 94, in which the idle distance pressure P_{D} is set on the basis of the threshold value S1. Logically speaking, variation in the desired idle distance D can lead to the need for a changed idle distance pressure P_{D} to ensure that the gap between the spindle nut 34 and the piston top 38 is greater than the threshold value S1.

The method 86 furthermore comprises step 90, in which the electric motor 44 is energized and a measurement run is then carried out within the idle distance D. This makes it possible to carry out the control method 68 explained above. For this purpose, the electric motor 44 is first of all made to rotate and then operated in the idling mode (generator mode), thereby making it possible to detect the motor speed ω_{RC} in the generator mode of the electric motor 44 and to detect the back EMF U_{ind} induced by the motor rotation. This provides a method 86 which makes it possible to ensure appropriate idle distances D between the spindle nut 34 and the piston top 38 of the actuating piston 24 even though these would actually not be present on account of the operating situation of the braking device 10 since, for example, strong restoring elements are integrated into the braking device 10.

In addition, step 88 of the method 86 can also be developed further by the optional step 96, in which an operating pressure P_{Betrieb} that has already been exerted on the actuating piston 24 by means of the hydraulic fluid before the execution of the method 86 is maintained during the method 86, taking into account the idle distance pressure P_{D}. This makes it possible to continue using the braking device 10 in accordance with the functionality of the service brake 14, even while the method 86 is being executed. This avoids the situation where the service brake 14 has to be released to enable the method 86 to be executed. This enhances the functionality of the braking device 10.

In addition, the method 86 can be developed further by the optional step 98, in which, after the threshold value S1 is reached, the electric motor 44 is accelerated to a minimum idling speed ω_{Min} and then an induced back EMF U_{ind} is measured in the idling mode of the electric motor 44. By virtue of the minimum idling speed ω_{Min}, it is possible to exploit the fact that the speed determination by means of the asynchronous counter 66 within the control method 68 can take place with increased precision since averaging can be ensured.

In addition, the method 86 can comprise the optional step 100, in which, after acceleration of the electric motor 44 to the minimum idling speed ω_{Min} and measurement of the induced back EMF U_{ind}, the electric motor 44 is de-energized and the electric motor 44 continues to rotate during this process, e.g. on account of its inertia. This corresponds substantially to the state of the electric motor 44 during step 70 of the control method 68. The electric motor 44 is then operated in a generator mode, in which rotation of the rotor of the electric motor 44 brings about an induced back EMF U_{ind}.

The method 86 makes it possible to create the preconditions for the control method 68.

Certain exemplary arrangements disclosed here, for example the respective module(s), use circuits (e.g. one or more circuits) to implement standards, protocols, methods or technologies disclosed here, to functionally couple two or more components, to generate information, to process information, to analyse information, to generate signals, to code/decode signals, to convert signals, to transmit and/or receive signals, to control other devices etc. Circuits of any kind can be used.

In one exemplary arrangement, a circuit comprises, inter alia, one or more computing devices, such as a processor (e.g. a microprocessor), a central unit (CPU), a digital signal processor (DSP), an application-specific integrated circuit (ASIC), a field-programmable gate array (FPGA), a system on a chip (SoC) or similar, or any combinations thereof, and can comprise discrete digital or analogue circuit elements or electronics or combinations thereof. In one exemplary arrangement, the circuit comprises hardware circuit implementations (e.g. implementations in analogue circuits, implementations in digital circuits and the like, and combinations thereof).

In one exemplary arrangement, circuits comprise combinations of circuits and computer program products with software or firmware instructions which are stored on one or more computer-readable memories and interact to make a device execute one or more of the protocols, methods or technologies described here. In one exemplary arrangement, the circuit technology comprises circuits such as microprocessors or parts of microprocessors which require software, firmware and the like in order to operate. In one exemplary arrangement, the circuits comprise one or more processors or parts thereof and the associated software, firmware, hardware and the like.

In the present application, reference may be made to quantities and numbers. Unless explicitly stated, such quantities and numbers should not be regarded as restrictive but as illustrative for the possible quantities or numbers in connection with the present application. In this context, the term “plurality” may also be used in the present application to refer to a quantity or number. In this context, the term “plurality” refers to any number which is greater than one, e.g. two, three, four, five etc. The terms “about”, “approximately”, “close” etc. mean plus or minus 5% of the stated value.

Although the disclosure has been illustrated and described with reference to one or more implementations, those skilled in the art will identify equivalent changes and modifications when reading and understanding this description and the appended drawings. Even if a certain feature of the disclosure has been disclosed only with reference to one or more exemplary arrangements, this feature can be combined with one or more other features of the other exemplary arrangements, as may be desired and advantageous for a given application or special application.

1. A method for determining a motor speed constant of an electric motor of an electromechanical parking brake, which is integrated into a hydraulic service brake, wherein a spindle nut of the electromechanical parking brake is arranged at least partially within a hydraulically actuable actuating piston of a braking device so as to be displaceable such that the spindle nut is moveable against the actuating piston, the method comprising: determining if a required idle distance between the spindle nut and the actuating piston is absent, and if the required idle distance between the spindle nut and the actuating piston is absent, supplying the hydraulically actuable actuating piston of the braking device with a hydraulic fluid in accordance with an idle distance pressure and at least the idle distance is set, and energizing the electric motor and carrying out a measurement run within the idle distance.

2. The method according to claim 1, wherein the idle distance pressure is set during operation.

3. The method according to claim 1, wherein the idle distance is greater than a predetermined threshold value.

4. The method according to claim 3, wherein the idle distance pressure is set on the basis of the threshold value.

5. The method according to claim 1, wherein an operating pressure that has already been exerted on the actuating piston by the hydraulic fluid before the execution of the method is maintained during the method, taking into account the idle distance pressure.

6. The method according to claim 3, wherein, after the threshold value is reached, the electric motor is accelerated to a minimum idling speed and an induced back EMF is measured in an idling mode of the electric motor.

7. The method according to claim 6, wherein, after acceleration of the electric motor to the minimum idling speed and measurement of the induced back EMF, the electric motor is de-energized and the electric motor continues to rotated.

8. The method according to claim 1, wherein the idle distance is greater than a threshold value that is set during operation.

9. The method according to claim 8, wherein the idle distance pressure is set on the basis of the threshold value.

10. The method according to claim 2, wherein the idle distance is greater than a predetermined threshold value.
